(19) United States
(12) Patent Application Publication
(10) Pub. No.: US 2011/0091962 A1
(43) Pub. Date: Apr. 21, 2011

(54) Automated Stainer Having Stain Level Detection

(76) Inventors: Richard Carsillo, Hendersonville, NC (US); Harold Leighton, Tega Cay, SC (US)

(21) Appl. No.: 12/865,504

(22) PCT Filed: Jan. 29, 2009
(86) PCT No.: PCT/US09/32366

§ 371 Date: Dec. 28, 2010

Related U.S. Application Data
(60) Provisional application No. 61/025,234, filed on Jan. 31, 2008.

(51) Int. Cl. G01N 1/31

(52) U.S. Cl. 435/286.5; 422/67

(57) ABSTRACT

An automated slide staining apparatus for staining slide samples is disclosed. The slide staining apparatus includes cuvette chambers that are flooded with solutions to cover a slide fitting within the cuvette chamber. Filling and emptying the chamber accomplishes a dipping function on the slide. The cuvette chamber includes a drainage flute and level detectors therein for proper fluid use and removal. The staining apparatus is useful to perform Gram stains, hematology cytology, dermatology cytology, fecal cytology and the like. Further, the method of using the slide stainer of the present invention along with the process of staining slides using the slide stainer of the present invention is disclosed.

### RELATED APPLICATIONS

This application claims priority to U.S. Provisional Patent Application Ser. No. 61/025,234 filed on Jan. 31, 2008, and incorporated by reference in its entirety herein.

### BACKGROUND

The present invention relates to a slide staining apparatus. In particular, the present invention relates to an automated slide staining apparatus and a method of using the same.

Biological samples such as tissues and cells do not retain enough color after processing to make their components visible under a bright-field microscope. Thus, stains are widely used to add color or dies to highlight structures in these biological samples for research and medical diagnostic purposes.

The process of staining generally involves applying the sample to a slide and then immersing the slide with the sample in a compatible reagent or stain solution. Various chemical formulations are used to highlight different tissues and cells that absorb particular reagents or stains. After dipping the slide into the reagents, sometimes multiple times, the staining is followed by rinsing and observation. The stains highlight various biological structures in the sample. The rinsing steps remove surface dyes that have not been absorbed by the cells of interest.

The process of staining can be carried out either manually or by using automated staining machines. Automated staining machines are, however, more desirable as compared to manual staining as they are cost efficient, accurate, and allow consistent staining.

Automated slide stainers are widely used to stain tissues for medical diagnostic purposes.

For example, U.S. Pat. No. 4,543,236 (von Gise 1985) discloses an incubating apparatus for automatic treatment of histological preparations. The incubating apparatus consists of an incubating unit holding the preparations to be treated, which is supplied with reagents from a reagents storage through a supply section. A computerized control section implements automatic sequencing of reagent input.

U.S. Pat. No. 5,595,707 (Copeland 1997) discloses an automated staining apparatus having a reagent application zone and a reagent supply zone. The reagent is spread over the slide by vortex agitation (centrifugal rotation) in the presence of an evaporation inhibitor. The reagent is removed from a slide by either blowing with a gas stream or flushing with a different liquid reagent. Liquid falls off the slide into a catch basin. The apparatus is geared toward DNA samples, ELISA tests, and the like.

U.S. Pat. No. 6,096,271 (Bogen 2000) shows a slide staining device for the application and removal of reagents to biological tissue sections mounted on microscope slides. The invention includes an aspiration head that removes liquid from the entire surface of the microscope slide held in a rotating carousel. The aspiration head vacuums the slide in areas other than the biological sample.

U.S. Pat. No. 6,468,764 (Gibbs 2002) describes a method of testing the decolorizaton result after washing a Gram's Stain with alcohol. The stain is applied to the sample as discussed above, and then a decolorizing fluid is washed over the slide to remove excess stain. Stain absorbed into the tissue or cellular structure of interest remains in the sample. The amount of stain in the rinse, therefore, indicates how well the rest of the sample has been flushed and decolorized. The goal is to maximize the contrast between absorbed stain in the biological material being tested and the rest of the sample. The patent discloses a method of testing the decolorizing fluid for light transmission to determine how much of the stain has washed off the slide. This light transmission level is compared to a known value to determine if sufficient decolorization has occurred or if the slide needs additional washings.

U.S. Pat. No. 6,585,936 (Shah 2003) shows a slide stainer that uses an automated arm to dip the slides in appropriate reagents. The automated slide stainer can be programmed by an operator to automatically perform a staining procedure to stain, rinse, and dry slides. Another automated stainer using mechanical lifts is shown in U.S. Pat. No. 6,635,225 (Thiem 2003). In the '225 patent, multiple slides sit in a basket, and the basket is dipped into appropriate reagent basins.

More recent patent applications in this field include U.S. Publication Nos. 2007/0128073 (Tappen 2007) and 2006/0046298 (Key 2006). Both of these applications use robotics to physically move the slides into areas for smearing with a biological sample, fixing the sample with a fixing agent, staining the sample, or drying the slide. The mechanical parts necessary to accomplish the robotic mechanisms make these devices cost prohibitive and require numerous maintenance operations.

Although others staining equipment has been disclosed in earlier products, no single apparatus provides for multiple testing capabilities with a minimum number of moving parts. Accordingly, there is a need for an efficient, inexpensive, accurate, and easy to use apparatus for staining slides of biological samples.

### SUMMARY OF THE INVENTION

In one aspect, the present invention is an automated slide stainer for staining biological tissues which includes a standalone countertop unit and thus can be conveniently installed in a laboratory.

In another aspect, the present invention is an automated slide stainer that can stain a biological tissue in less than about 45 seconds.

In yet another aspect, the present invention is an automated slide stainer which can be programmed at different settings according to the preferences of at least five users.

In yet another aspect, the present invention is an automated slide stainer that minimizes the quantity of stain used for staining the biological tissues by incorporating level sensors into the slide cuvette where the staining fluid covers the slide.

In yet another aspect, the present invention is an automated slide stainer that can perform a variety of specialized stainings for various categories such as hematology, dermatology, ear cytology, and fecal cytology.

In yet another aspect, the present invention is a method of using the automated slide stainer for staining a tissue or cell for research or medical diagnostic purposes (e.g., in the field of hematology and dermatology).

The foregoing, as well as other objectives and advantages of the present invention and the manner in which the same are accomplished, are further specified within the following detailed description.

### BRIEF DESCRIPTION OF THE DRAWINGS

FIG. 1 is a perspective view of the automated stainer according to this invention.

FIG. 2 is a front side view of the automated stainer showing the user inserting a slide into the cuvette chamber for staining.

FIG. 3 is a side view of the automated stainer showing the user removing the stained slide and placing the slide in the drying rack.

FIG. 4 is an interior view of the automated stainer showing rotary pumps with tubular lines for attaching to reagents at one end and the cuvette chamber at the other end.

FIG. 5 is a close-up view of one rotary pump according to the automated stainer of this invention.

FIG. 6 is a side view of one rotary pump used in the automated stainer of this invention.

FIG. 7 is a side view of one cuvette chamber adapted to receive the tubular lines from the reagent source.

FIG. 8 is a cross view of the front half of the cuvette chamber of this invention taken from the direction shown by the arrowed No. 8 of FIG. 7.

FIG. 9 is a cross view of the back half of the cuvette taken from the direction shown by the arrowed No. 9 of FIG. 7.

FIG. 10 is a rear view of the cuvette of FIG. 7 taken from the perspective of the arrowed No. 10 of FIG. 7.

### DETAILED DESCRIPTION

The invention embraces an automated slide stainer apparatus (10) used for staining biological samples (e.g., tissues and cells). The automated stainer (10) controls the mechanical operations via a computerized control system operated via digital electronics. The electronics include those electrical components known in the art and implemented on a printed circuit board (PCB) housed in the automated stainer (10). The data that controls the electronics are transmitted via electrical circuits to pump motors (55) (for moving staining solutions through the system) and to user screens (45) on the unit (enabling digital key pad data entry for selecting the stain to be used). The control circuitry and the programming necessary to implement the invention allow multiple users to customize their views for data and test selection and customize the way that the unit operates.

In particular, the invention embraces an automated slide stainer (10) that includes a standalone countertop unit (20) for in vitro diagnostic use.

The present apparatus functions most efficiently and accurately when used with slides (30) prepared with single cell layer biological samples.

In one embodiment, the present stainer may be programmed to accept a specific kind of staining solution for flowing into the cuvette chamber (25). This may be achieved by providing the solution in a source container (17) with a unique identifier number. The stainer (10) is programmed to count the number of times the solution has filled a cuvette chamber (25). Upon reaching a maximum number, set by the solution manufacturer, the system will detect that an appropriate solution has been depleted. The system will resume operation only upon entering a valid identification number from a new bottle of approved solution.

The automated slide stainer (10) of the present invention performs a variety of specialized stainings in various fields including hematology, dermatology, ear cytology, and fecal cytology. These fields are particularly relevant to the field of veterinary medicine.

In one aspect, the automated slide stainer (10) of the present invention includes a slide staining unit (20) and an A/C power adapter for plugging into a standard wall outlet.

To facilitate the preparation of a slide (30) for staining, the slide stainer apparatus may also include a preparation tray and workstations. As noted above, the slide (30) is prepared with a biological sample affixed to the slide (30) with a fixative that is known in the art. The slide (30) is subjected to stains and reagents that cause the biological components of interest to absorb the stain and show more brightly for medicinal observation. The non-absorbed stains are rinsed off by a different solution. Used stains, reagents, and rinses are washed into a waste receptacle (18) associated with the unit (10).

The automated stainer (10) of this invention avoids the standard procedure of dipping slides into various stains and rinses, whether performed manually or via robotics. Instead, the automated stainer (10) allows the slide (30) to remain stationary in a cuvette chamber (25) as the stains, reagents, and rinses flow up and down the surface of the slide. The up and down flow is accomplished by the stainer unit (20) pumping the appropriate solutions from their respective containers (17) through tubular lines (15, 16) to the cuvette chamber (25). By filling and emptying the cuvette chamber (25), the automated stainer (10) accomplishes the same result as standard old-fashioned dipping motions with the slide in hand. Only in the new stainer, the fluids are in up and down motion within the cuvette chamber (25) instead of the slide being dipped.

Described differently, the slide (30) fits within the cuvette chamber (25) and holds a biological sample thereon. An appropriate stain is selected for filling the cuvette chamber (25), thereby flooding the slide (30) and its sample. The sample absorbs the stain as necessary for certain biological factors within the sample to show up under a microscope (i.e., the regions of the sample that are being tested are likely to absorb the stain). Next, the automated stainer (10) empties the cuvette chamber (25) by allowing the fluid therein to flow back into the tubular line (16A). This process is repeated according to standards known in the art for each kind of biological sample and each kind of stain or reagent. When the filling and emptying process within the cuvette chamber (25) has been completed a preferred number of times (i.e., when the process has completed a certain number of “dips”), the fluid used for filling the cuvette is allowed to escape to a different tubular line (16B) connected to the cuvette chamber (25) and directed to a waste receptacle (18).

Further, the stainer apparatus may include a drying rack (40) for drying slides after staining. The drying rack (40) may include a fan (42) that can be programmed to automatically turn off after it has operated for a particular duration. The drying rack (40) with the fan is optionally attached to a computerized control system housed within the stainer for power.

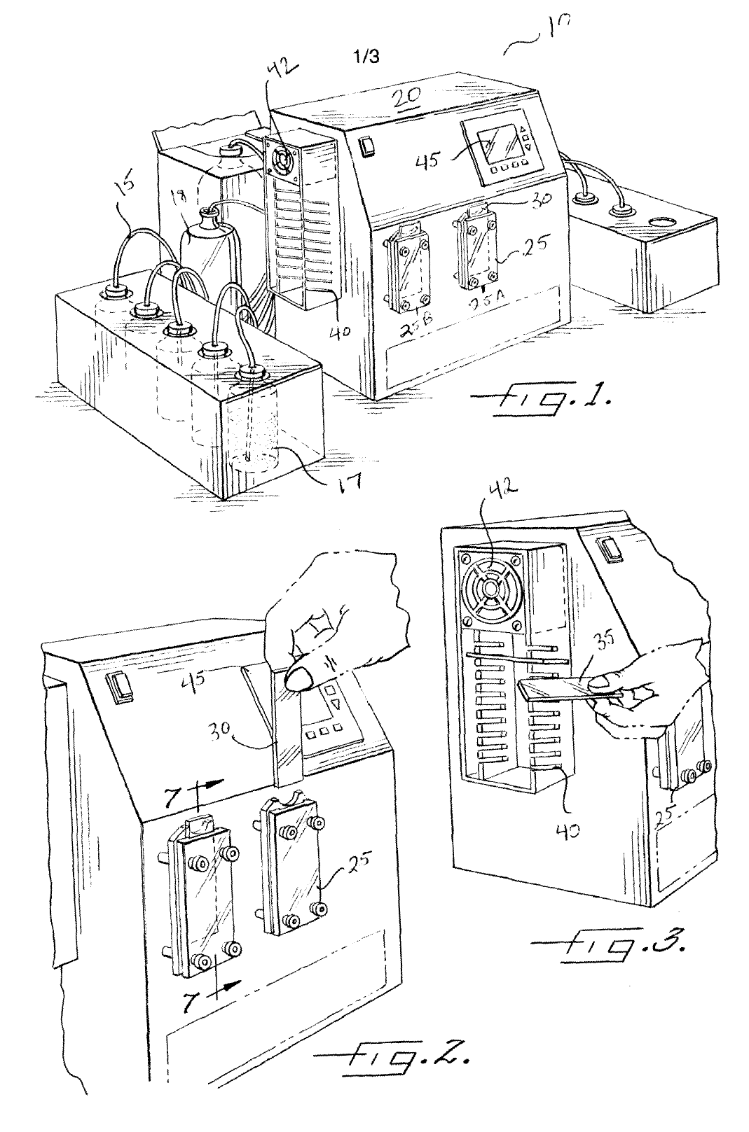

The present slide stainer may further include one or more source containers (e.g., bottles) (17) that include solutions of stains (such as Gram's stain and stains used in hematology, dermatology and other tests) or rinse liquids etc. These bottles, as shown in FIG. 1, may be conveniently located to the side of the stainer.

In one embodiment, the present slide stainer apparatus includes at least eight containers (referred to herein as “source containers”) wherein at least four containers hold Gram's stain solutions (e.g., crystal violet, iodine, decolorizer, safranin, and a rinse) and at least four containers hold solutions for other types of stains (e.g., a fixative such as methanol, red stain, blue stain, and an aqueous rinse solution such as water and alcohol). The stains other than Gram's stains are often used in diagnostic tests such as hematology, dermatology, ear cytology, and fecal cytology.

In addition, the slide stainer apparatus (10) may include at least one rinse solution container connected to the slide staining unit and containing rinse liquid. Such a rinse container typically supplies rinse liquids (e.g., buffered water) to facilitate Gram's staining procedures.

Further, the present slide stainer apparatus preferably includes one or more waste containers connected to the slide staining unit by flexible tubular lines. After a solution has been used as a stain or a rinse, the used solution is emptied from the cuvette into the waste container.

The aforementioned stain solution containers, the rinse containers, and the waste containers, along with the slide staining unit of the present invention are typically placed together on a tray to hold the whole assembly in a convenient location in a laboratory or veterinarian's office.

In one embodiment, the slide staining unit of the present slide stainer apparatus contains at least two cuvette chambers (25A, 25B) (i.e., left cuvette chamber and right cuvette chamber) for receiving slides (30) for staining.

These cuvette chambers (25) may be designed to receive either glass or plastic slides (30). Further, more than one slide may be tested at the same time in two different cuvette chambers or even in the same cuvette chamber.

The aforementioned cuvette chambers (25) preferably have a two piece design (31, 32) that facilitates the opening and cleaning of these chambers. The two pieces (31, 32) then fit on top of one another to define a space there between in which the slide fits for staining. Further, these two pieces of a cuvette chamber include a gasket (29) that seals the intersection of the two piece construction to minimize residual fluid in these chambers and to prevent leaking. Although the drawings herein show cuvette chambers that hold only one slide each, the cuvette chamber could be made with sufficient width and/or depth to stain more than one slide at a time.

The bottom of one of the pieces of the aforementioned cuvette chamber includes openings, or ports (26, 27), to receive supply tubes (16) (i.e., tubes that supply stain or rinse solutions) and waste tubes (i.e., tubes that drain the used solutions from the cuvette chambers). A respective tubular line (16) is attached to an associated port (26, 27) that leads to the interior of a respective cuvette chamber (25). Each cuvette chamber (25) has an inlet port (26) for each line connected to one of the stains, reagents, and rinsing fluids, and an outlet port connected to the waste container (18). Each port (27) engages a respective tubular line (16) and is sufficiently sealed to avoid leaking. Typically, the tubular lines (15, 16) are made of a flexible polymer that is self-sealing when it engages the port (26, 27).

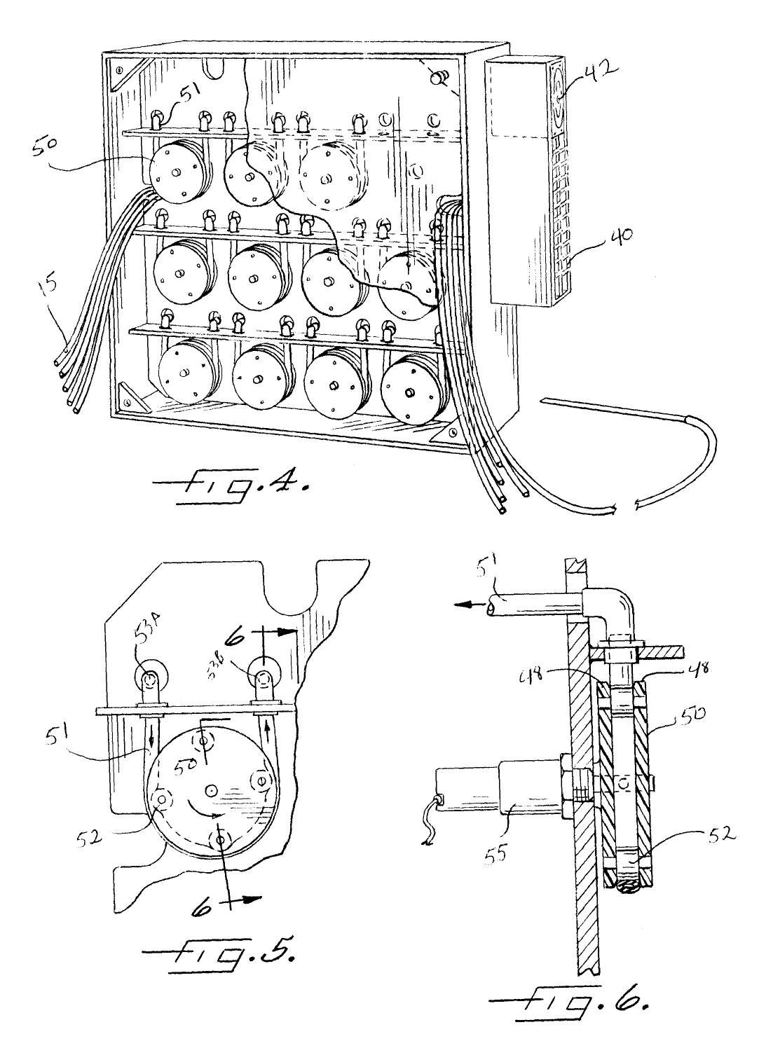

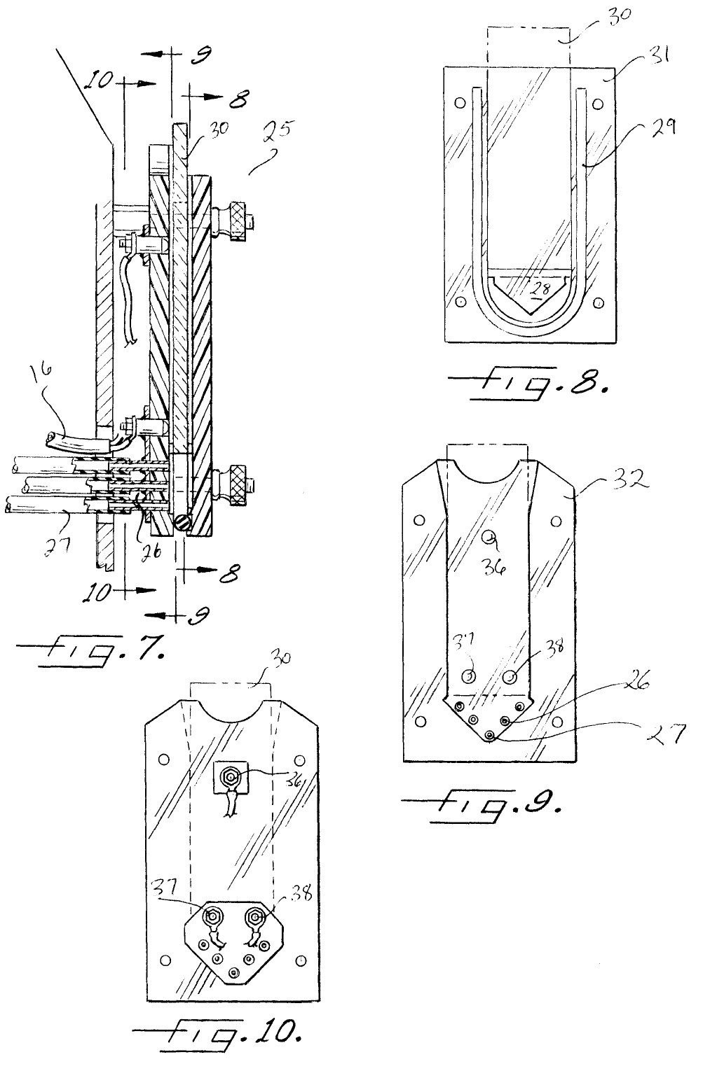

The flow into and out of each of these ports (26, 27) in the cuvette chamber (25) is controlled by a rotary pump (50) engaging each of the tubular lines. As shown in FIG. 4, a respective rotary pump (50) controls the amount of stain, reagent, rinse, or waste fluid moving through any given tubular line (15, 16) into and out of a respective cuvette chamber (25). To accomplish this function, each rotary pump (50) includes a control tube (51) that engages a respective outer roller (52). The control tube (51) wraps around at least a portion of the circumference of the rotary pump (50). The control tube (51) includes an inlet section (53A) and an outlet section (53B). The inlet section (53A) engages a portion of a tubular line (15) extending from a fluid (stain, solution, etc.). In more definitive terminology, the tubular line (15) extending from the fluid source container (17) to the inlet section (53A) of the rotary pump control tube (51) may be referred to as a source tube (15). The outlet section (53B) of the control tube (51) around the pump (50) engages a different tubular line (16) that extends to a respective port (26, 27) into the interior of the cuvette chamber (25). This different tubular line is referred to as a solution line (16). The rotary pump (50) essentially squeezes the control section (51) by rotation and forces fluids into and/or out of the appropriate tubular line (15, 16). The squeezing creates a vacuum in the line to suck the fluid and move it through the system. The direction of the rotation of the pump (50) determines whether the fluid flows into or out of the tubular line (15, 16). In this way, the automated stainer (10) can use the direction of the pump rotation to move fluid into and out of the cuvette chamber (25) efficiently. Each fluid used in this invention has its own storage source container (17) (typically a bottle), its own tubular line (15, 16), its own rotary pump (50), and its own port (26, 27) for entering and exiting the cuvette chamber (25). As shown in FIG. 6, the rotary pump (50) is controlled by a motor (55) within the staining unit (20). The motor (55) is electronically controlled by a computerized control system enabled on the printed circuit board housed in the stainer unit (10).

The tubular lines (15, 16) to and from the rotary pump (50) control tube (51) are of a sufficient length to ensure that fluids within the end portion of the line, i.e., entering the cuvette chamber port, do not move backward into the source container. In other words, the automated stainer of this invention allows for fluids at the cuvette end of a tubular line (16) to be pushed into and extracted out of the cuvette chamber (25) back and forth into and out of the end of the tubular line (16). This allows the same volume of fluid to perform multiple dips from the end of the line. When the number of dips has reached a maximum (i.e., when the cuvette chamber (25) has been filled and emptied the correct number of times), the fluid exits the cuvette chamber (25) through a different port (27) to the waste container (18). This process avoids any contamination due to back fill from the cuvette chamber (25) into the original source container (17).

The cuvette chamber (25) further includes level sensors (36, 37, 38) for (i) determining the height of a solution in the cuvette chamber (25) and (ii) preventing the fluid from rising beyond a predetermined height. In one embodiment, the cuvette chamber (25) includes three level sensors—one at the top or highest solution level (36) and two along the bottom or lowest solution level (37, 38). The two bottom level sensors (37, 38) are at substantially equal heights. One of the bottom sensors (37) is connected to ground. The other bottom sensor (38) and the top sensor (36) are connected to a positive voltage, e.g., 5 volts. In operation, when the solution begins to fill the cuvette chamber, the conductivity of the solution causes the voltage between the two bottom level sensors to drop. The computerized control system is programmed to respond to that drop by recording that the cuvette chamber fill process is active and working, thereby allowing the pumping function to continue. As the solution level in the cuvette chamber rises to a maximum desired height, the solution surrounds the top level sensor. At this point, the conductivity of the solution decreases the voltage drop between the top level sensor and the bottom ground level sensor. This change indicates that the solution is at maximum height. At this point, the computerized control system stops the pump to avoid over-filling or over-flowing the cuvette chamber.

In one aspect the cuvette chamber (25) may also include a triangular piece (i.e., a flute) (28) to aid in the draining of liquids from the chamber (25). See FIG. 8. Thus, the flute (28) minimizes contamination and optimizes accurate results. The flute (28) is the bottom edge of the cuvette chamber shaped in a downward triangle to basically extend the vertically parallel edges of the slide in the cuvette chamber downward to a triangular vertex at the bottom of the cuvette chamber (25). The angled sides of the flute (28) assist residual solution in the cuvette chamber in draining into a waste container.

The aforementioned containers (17) with stain solutions are connected to the slide staining unit (20) by tubular lines (15, 16). These lines are inserted into the solution containers on one end and attached to similar flexible control tubes (51) of the pumps (50) on the other end. The solution, or source, end of the tubular lines (15) may be formed of a corrosive resistant metal that connects to the flexible polymer of the tubular lines (15). The flexible control tube (51) of one of the pumps connects the slide staining unit to the waste containers (18) for eventually draining the liquid out of the cuvette chambers that hold the slides to be stained.

The slide stainer of the present invention may also include pumps (50) (e.g., peristaltic or rotary pumps) for moving the staining, rinse, and waste solutions back and forth from the solution containers (17) to the cuvette chambers (25). In one embodiment, the rotary pump (50) includes pump wheels (48) to pump liquid to the cuvette chambers (25) or to drain liquid from the same. The pump wheels (48) of this invention are generally formed of two discs (48) connected by roller bars (52) to form a generally cylindrical structure. Flexible control tubes (51) are wrapped around at least a portion of the circumference of the pump wheels (48) so that the control tubes (51) engage the roller bars (52). As the pump wheels turn, on command from the control system enabled on the printed circuit board, the roller bars apply pressure to the flexible control tubes to squeeze any solution in the control tube forward or backward, depending upon the direction of the pump wheel. As shown in FIG. 1, solutions from associated containers replenish the solution squeezed out of the flexible tubes. In other words, source tubes (15), a kind of tubular line, are in fluid communication with the solution containers (17) on one end and the flexible control tubes (51) of the pumps (50) on the other end. The flexible control tubes (51) are further connected to tubular lines that access the interior of the cuvette chamber. These tubular lines, that enter a port in the cuvette chamber, may be referred to as solution tubes (16). The flexible control tubes (51) on the pumps (50) connect to these tubular lines (solution tubes (16)) for moving the solution and to supply tubes that empty into a respective cuvette chamber (25).

The flexible control tubes (51) wrapped around the pump wheels (48) of this invention are particularly suited for the pumping operation of the staining apparatus. The flexible control tubes (51) are stretch resistant, meaning that the volume of solution moving through a section of the flexible control tube remains constant. In other tubing configurations, the tubing stretches, which reduces the volume of solution passing through a given tube section, due to smaller cross section size of stretched tube. The flexible control tubes (51) of this invention, therefore, give the most consistent pump volume available.

In one embodiment, the slide stainer has nine pump wheels and respective tubular lines (i.e., the supply pumps) to supply liquid to the cuvette chambers and two pump wheels and two waste tubes (i.e., the waste pumps) to help drain out the liquid from the respective cuvette chambers.

In this embodiment, five pumps (i.e., four supply pumps and one waste pump) are attached to the right cuvette chamber (for Gram's stains). Each of these pumps has a flexible control tube attached around its pump wheel which connects each of aforementioned solution tubes or waste tube. Similarly, the remaining six pumps (i.e., five supply pump and one waste pump) are attached to the left cuvette chamber (for tests such as hematology, ear cytology, fecal, and dermal). Each of these pumps has a flexible control tube attached around its pump wheels which connects each of aforementioned solution tubes or waste tube.

In one aspect, all the pumps of the present apparatus are housed as one assembly on a mounting plate (i.e., the Pump Mounting Plate). Typically, the supply pumps run in forward and reverse direction. Whereas, the waste pumps typically run only in one direction, e.g., reverse to empty the cuvette chamber into a waste container.

In one embodiment, the aforementioned pump includes four roller wheels that help squeeze the tubes stretched around the pump wheels.

The slide stainer apparatus may further include a display screen (45) for displaying information regarding the staining process. The display screen (45) is controlled by appropriate computerized electronics on the printed circuit board (“PCB”). The slide stainer apparatus may also include a keypad to program various steps involved in the staining process. The keypad and the display are in electronic communication with the PCB and therefore the rest of the apparatus.

In one embodiment, the present apparatus can be programmed to be used by five different operators. Each operator has customizable options that can be stored in the electronics (e.g., dip volumes, timing, alarms, and default screens). The printed circuit board drives the circuit and controls the functioning of various parts of the apparatus such as the microprocessor, pumps, level sensors, the LEDs, buzzers, and display.

In yet another aspect, the invention embraces a method for using the slide staining apparatus. In one embodiment, the method enabled by the slide stainer of the present invention is used by turning the device on (e.g., by turning the power switch on). The stainer then runs its self-priming/initialization protocol which typically includes the turning on the waste pumps. While the waste pumps are running, each supply pump runs for about 10 to 20 seconds to fill the source tubes connected to a respective solution and a respective solution tube that accesses a port in a respective cuvette chamber. Each supply pump takes its turn. Once all tubular lines are full, the waste pump continues for an additional about 10 to 20 seconds to make sure the cuvette chamber is empty. This process is repeated for the supply and waste pumps connected to the left and the right cuvette chambers.

Thereafter, from the main menu, the operator selects his/her user designation, the specimen category/origin, and the staining technique(s). A properly prepared and dried slide is placed into the cuvette chamber indicated by a flashing, colored LED. Thereafter, the stainer performs the requested staining technique(s). As noted above, the tests may be directed to hematology, dermatology, ear cytology, fecal cytology, Gram's stain, and other tests that are susceptible to automation. The colored LED begins flashing again and the stainer emits a series of loud beeps when the staining is complete. The operator silences the beeps and removes the slide(s), placing it/them in the drying rack. The next slide(s) is/are stained by repeating the above. Once dry, the slide(s) are examined as standard laboratory procedure dictates.

The staining process can be aborted at anytime during the staining cycle by pressing the Abort button. The stainer will then drain the cuvette chamber, flush the lines and send the user back to the main menu.

Once the staining is complete (the number of dips is located on the screen), the stainer unit will alert the operator (i.e., by beeping and/or flashing LED). The slide(s) should be removed and placed in the drying rack. For this purpose, the stainer has an optional fan that is either manually controlled or can be pre-programmed to start and stop in order to dry the slide(s).

In one aspect, the present stainer apparatus is designed to stain dry slides in all standard thickness. Preferably, these slides should be prepared according to the standard operating procedures. Slides intended for Gram staining should be heat fixed and the soot wiped off. Slides intended for all other staining techniques may be air dried or placed into the optional drying rack until the slide(s) are ready for staining.

In one embodiment, the present invention is a process of staining slides by the automatic slide stainer.

The cuvette chambers are first cleaned by rinse solutions or aqueous solutions depending on the type of staining (i.e., gram staining or hematology staining etc.).

Thereafter the slides containing samples for staining are inserted in the cuvette chambers.

The appropriate stain solution is then flooded into the cuvette chamber(s) through the appropriate supply tube connected to opening at the bottom of the cuvette chamber. The level sensors present in the cuvette chamber allow the solution to fill up to a predetermined height. The length of the presence of the solution in the cuvette chamber and the amount of time the sample is dipped in the solution can be either programmed to correspond to the preferences of up to five operators. Alternatively, the factory set standard staining procedure can be followed.

Table 1 indicates the default staining protocols that the present staining apparatus may include. The apparatus automates manual slide dipping by allowing the slide to remain stationary in the cuvette chamber and having the solution fill to cover the slide and then drain to expose the slide to air. This protocol simulates the old-fashioned dipping process where the slide was dipped into the solution. Instead, by the method presented here, the solution is flooded around the slide. The result is the same, yet the pump wheels do all the work. As noted below, the term “dip” means the process by which the cuvette chamber is flooded and then drained. This “dipping” process may be repeated by the forward and reverse action of a respective pump wheel. The cuvette chamber is flooded with the proper amount of solution around the slide by the forward action of the pump wheel. The solution then flows back into the supply tube and flexible tube around the pump wheel by order of the PCB for the pump wheel to move in the opposite direction. This process may be repeated for the programmed number of times before the cuvette chamber is emptied into the waste tube for disposal in the waste container.

TABLE 1
THE STAINER IS EQUIPPED WITH THE FOLLOWING
FACTORY SET STANDARD STAINING PROTOCOLS:

| | | Right Side Cuvette | |
|---|---|---|---|
| Left Side Cuvette | | Hematology-Ear-Dermatology | |
| Gram Stain | | Fecal-Urinalysis-Other | |
| Solution 1 - | 60 Seconds | Solution 1 - | 1 Second |
| | 1 Immersion | | 4 Dips |
| Solution 2 - | 60 Seconds | Solution 2 - | 60 Seconds |
| | 1 Immersion | | 5 Dips |
| Solution 3 - | 1 Second | Solution 3 - | 1 Second |
| | 5 Dips | | 6 Dips |
| Solution 4 - | 60 Seconds | Solution 4 - | 1 Second |
| | 1 Immersion | | 7 Dips |
| Solution 5 - | 1 Second | | |
| | 6 Dips | | |

Alternatively, the staining protocols of the slide stainer can be customized according to preferences of its user. Further, a user can, at any time restore the default staining protocols as needed.

After each staining cycle, the contents of the cuvette chamber are flushed out through the waste tube opening at the bottom of the cuvette chamber. Alternatively, if the sample is to be dipped in the same solution again, the solution is pumped in the reverse direction into the supply tubes and the aforementioned dipping process is repeated. The chamber is flooded with the same solution. Once the dipping process with a particular solution is completed, the used solution is flushed out from the cuvette chamber through the waste tube opening.

Further, empty stain and rinse solution containers used with the present stainer can be replaced and the waste containers emptied.

In the specification and drawings, typical embodiments of the invention have been disclosed and, although specific terms have been employed, they have been used in a generic and descriptive sense only and not for purposes of limitation. Different kinds of tubular lines, pumps, solution containers, and other components may be substituted for the parts disclosed herein and still fall within the ambit of the invention. The invention is set forth in the claims below.

1. A slide staining apparatus for exposing specimens on a slide to fluids for biological testing, comprising:
a cuvette chamber for holding a slide with a specimen affixed to the slide;
at least one port for pumping fluid into the cuvette chamber;
at least one port for removing the fluid from the cuvette chamber;
at least one pair of level sensors in the cuvette chamber to determine the height that the fluid rises into the cuvette chamber.

2. A slide staining apparatus according to claim 1, comprising a first pair of level sensors for determining that the minimum height that the fluid rises in the cuvette chamber has been reached.

3. A slide staining apparatus according to claim 2, comprising a second pair of level sensors for determining that the maximum height that the fluid rises in the cuvette chamber has been reached.

4. A slide staining apparatus according to claim 3, wherein said level sensors are in electronic communication with a computerized control system.

5. A slide staining apparatus according to claim 4, wherein said computerized control system controls pumps that move the fluid into the cuvette chamber.

6. A slide staining apparatus according to claim 5, wherein said computerized control system stops the fluid pumping process when the maximum height of fluid has been reached in the cuvette chamber.

7. A slide staining apparatus according to claim 1, further comprising a rotary pump for controlling the fluid moving into the cuvette chamber.

8. A slide staining apparatus according to claim 7, wherein the rotary pump engages a control tube of a sufficiently flexible construction to maintain its volume in the presence of rotation and to ensure an accurate volume of fluid dispensed into the cuvette chamber.

9. A slide staining apparatus according to claim 1, wherein the slide staining apparatus comprises at least two cuvette chambers connected by tubular lines to fluid source containers and at least one waste container.

10. A slide staining apparatus having fluid source containers connected to at least one cuvette chamber via tubular lines controlled by pumps directed by a computerized control system, the slide staining apparatus comprising:
at least one cuvette chamber for holding a slide with a biological specimen thereon;
at least one tubular line connected to said cuvette chamber for delivering a solution to said cuvette chamber;
at least one tubular line connected to said cuvette chamber for draining the solution from said cuvette chamber to a waste container;
a flute at one end of the cuvette chamber, the flute promoting drainage of the solution off the slide and into a tubular line.

11. A slide staining apparatus according to claim 10, wherein said tubular line is a solution line that repeatedly fills the cuvette chamber with the same solution.

12. A slide staining apparatus according to claim 10, wherein said tubular line directs the solution out of the cuvette and into a waste container.

13. A slide staining apparatus according to claim 10, wherein the apparatus is used for a biological test.

14. A slide staining apparatus according to claim 10, wherein the apparatus is used for a Gram's stain test.

15. A slide staining apparatus according to claim 10, wherein the apparatus is used for a biological test selected from the group consisting of hematology, dermatology, ear cytology, and fecal cytology.

16. A slide staining apparatus according to claim 10, wherein the slide staining apparatus is used in a veterinarian environment.

17. A slide staining apparatus according to claim 10, further comprising a rotary pump connected to a digital control system for controlling the volume of fluid pumped into and out of the cuvette chamber.

18. A slide staining apparatus according to claim 10, further comprising at least one pair of level sensors within said cuvette chamber.

19. A slide staining apparatus according to claim 10, further comprising multiple source containers of solutions for filling said cuvette chamber.

20. A slide staining apparatus according to claim 10, wherein each source container engages a source line connected to a control tube associated with a respective rotary pump, wherein the rotary pump moves the solution into and out of the cuvette.
